(19) United States
(12) Patent Application Publication
(10) Pub. No.: US 2006/0019112 A1
(43) Pub. Date: Jan. 26, 2006

(54) Use of branched polyethylenes in multilayer films and resealable closures

(76) Inventors: David A. Holmes, Wilmington, DE (US); Dewey Lynn Kerbow, Landenburg, PA (US); Slawomir Opuszko, Duncan, SC (US); Tina V. Lorenzo-Moore, Spartanburg, SC (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/080,759

(22) Filed: Mar. 15, 2005

Related U.S. Application Data
(60) Provisional application No. 60/553,094, filed on Mar. 15, 2004.
(60) Provisional application No. 60/571,464, filed on May 14, 2004.

(51) Int. Cl. B32B 27/00

(52) U.S. Cl. 428/500

(57) ABSTRACT

Branched polyethylenes of density up to about 0.875 g/cc are used as a component in articles that can be pressure-sealed and unsealed repeatedly. Such articles include multilayer films that contain the branched polyethylene and another thermoplastic and pressure-resealable closures comprising a sealing surface that comprises the branched polyethylene and a sealing surface that comprises a thermoplastic. The multilayer film and closures are particularly useful in packaging, especially plastic packaging, such as bags, pouches, and vacuum skin packaging, to package a large variety of goods.

### FIELD OF THE INVENTION

The present invention is directed to branched polyethylenes. The invention further relates to multilayer films, resealable closures and packaging articles, made from the branched polyethylenes. The polyethylenes are particularly useful in making articles having a heat-seal properties, as well as reclosable packaging articles.

### TECHNICAL BACKGROUND

Plastics packaging is ubiquitous in modern society. Many different items are stored and/or sold in such packaging, and the packaging may be in the form of bags, blister wraps, boxes, cartons, and pouches. Most commonly the plastic employed is a thermoplastic. Many containers, and seams in those containers, are sealed by “heat-sealing”, which is the application of heat and pressure to cause the polymers at the surfaces that are being joined (sealed) to flow and adhere to one another.

Most thermoplastics can be heat-sealed if heated to a sufficiently high temperature and subjected to a sufficiently high pressure for a sufficient time. Polyolefin thermoplastics such as polyethylene (PE) and polypropylene (PP) and their many variations can be heat-sealed. For example, high density PE, low density PE, and linear low density PE can be heat-sealed. Since so many items are sold in heat-sealed packaging, the speed at which strong heat-seals can be produced is economically important, and polymeric compositions with improved heat-sealing properties have been sought.

It has been found that polyethylenes that have a plurality of branch lengths in the polymer are especially advantageous for heat-sealing properties; see U.S. Pat. No. 6,620,897 and World Patent Applications 03/039958 and 03/040199. In addition, World Patent Application 03/039866 describes the use of polyethylenes having a plurality of branch lengths and a density of 0.85 to 0.89 g/cc in surfaces which are heat-sealable and pressure-reclosable.

All of the polymers in the above mentioned patent and patent applications were made with so-called “chain-walking” late transition metal-containing polymerization catalysts that are believed to give polyethylenes with randomly branched structures. The branches are of randomly varying lengths, and branches on branches (such as iso-butyl branches) can be produced. Chain-walking is disclosed in, for example, S. D. Ittel, et al., Chem. Rev., vol. 100, p. 1180-1182 (2000). It was believed that this randomness in the polyethylene formed provided good heat-sealing and pressure-resealing properties.

### SUMMARY OF THE INVENTION

The present invention is directed to branched polyethylenes of density up to about 0.875 g/cc. The polyethylenes can be used as a component in making articles that can be pressure-sealed and unsealed repeatedly.

In one embodiment, the present invention is directed to a multilayer film comprising:
(a) a first layer comprising a branched polyethylene having a density of up to about 0.875 g/cc, said first layer being an outer layer that is hermetically heat-sealable and pressure-reclosable; and
(b) a second layer comprising a different thermoplastic polymer.

The present invention also provides a packaging article comprising a multilayer film having a first layer and a second layer, the first layer being an inside layer of the article, the first layer comprising a branched polyethylene having a density of up to about 0.875 g/cc, the second layer comprising a different thermoplastic polymer, with the inside layer heat sealed to itself or another component of the packaging article, and the inside layer being hermetically heat-sealable and pressure-reclosable to itself or to the other component of the packaging article.

The present invention also provides a process for making a sealed article, comprising:
(a) providing a multilayer film having a first layer which is a heat-sealable, pressure reclosable layer and which comprises a branched polyethylene having a density of up to about 0.875 g/cc; and
(b) heat-sealing the first layer of the multilayer film to itself or to another article by heating the first layer to a temperature of at least 50° C.

The present invention also provides a hermetically heat-sealable, pressure-reclosable multilayer film comprising:
(a) a first layer which is an outer film layer and which comprises a branched polyethylene having a density of up to about 0.875 g/cc; and
(b) a second layer which is an outer, heat-resistant layer comprising a thermoplastic polyolefin having a DSC melting point or glass transition temperature of at least about 100° C., the outer film layer of at least one of (A) and (B) having a coefficient of friction of less than 0.5 as measured by ASTM D 1894.

The present invention also provides a package comprising a tray having a lidding film adhered thereto, the tray having a support member, upwardly extending walls, and a flange above the upwardly extending walls, with the lidding film being a multilayer film having a first layer and a second layer, the first layer being an inside, heat-sealable, pressure-reclosable layer comprising a branched polyethylene having a density of up to about 0.875 g/cc and the second layer comprising a different thermoplastic polymer.

This invention provides an article having a pressure-resealable closure, comprising a first resealable surface and a second resealable surface, wherein a first material of said first resealable surface comprises a branched polyethylene having a density of up to about 0.875 g/cc and a second material of said second sealing surface comprises a thermoplastic.

Also described herein is a process for closing a closure, comprising applying pressure so as to squeeze together a first resealable surface and a second resealable surface, wherein a first material of said first resealable surface comprises a branched polyethylene having a density of up to about 0.875 g/cc and a second material of said second sealing surface comprises a thermoplastic.

### BRIEF DESCRIPTION OF THE DRAWINGS

FIG. 1 is an enlarged, schematic, cross-sectional view of a two-layer film suitable for use in the present invention.

FIG. 2 is a schematic of a process for preparing the two-layer film of FIG. 1.

FIG. 3 is a plot of heat-seal strength versus seal temperature for a series of films, each of which has a different branched polyethylene in the seal layer.

FIG. 4 is a plot of seal-strength of pressure-induced seal (i.e., reclosable seal) at room temperature as a function of repetitions of resealing the same areas of the same two film strips, for a series of five films each having a seal layer containing a branched polyethylene.

FIG. 5 is a plot of reclose seal strength versus density for the same five films.

### DETAILS OF THE INVENTION

The present invention is directed to branched polyethylenes of density up to about 0.875 g/cc. The branched polyethylenes are useful in making articles that can be pressure-sealed and unsealed repeatedly.

In one aspect, the present invention is directed to a multilayer film comprising:
(a) a first layer comprising a branched polyethylene having a density of up to about 0.875 g/cc, said first layer being an outer layer that is hermetically heat-sealable and pressure-reclosable; and
(b) a second layer comprising a different thermoplastic polymer.

Preferably, the branched polyethylene has:
(a) branches of only one, two, or three different branch lengths; or
(b) three or more branches of the formula —(CH₂CH₂)ₘH wherein m is an integer of one or more. The branched polyethylenes useful in articles and processes of the inventions described herein include homogeneous ethylene homopolymers and ethylene/alpha-olefin copolymers. In some applications, ethylene/alpha-olefin copolymers are preferred.

In particular, the branched polyethylene preferably has a density of up to about 0.875 g/cc; more preferably up to about 0.865 g/cc; more preferably up to about 0.86 g/cc; and preferably at least 0.84 g/cc. Preferably, the branched polyethylene comprises homogeneous ethylene/alpha-olefin copolymer. In one embodiment, the first layer is directly adhered to the second layer. The density of the branched polyethylene is measured by ASTM Method D-792-00.

The density of the branched polyethylene will usually depend on the proportion of carbon atoms in the polymer in the polymer branches. The higher this proportion, the lower the density of the polyethylene. Higher olefins (olefins with more carbon atoms) tend to be more efficient on a molar basis in lowering the density of the polyethylene. Therefore, for example, polyethylenes containing somewhat higher α-olefins, such as 1-hexene and/or 1-octene, or even higher α-olefins may be preferable for some applications. Useful commercially available branched copolymers include grades with a density of up to about 0.865 g/cc of Engage® polyolefin elastomer, available from DuPont Dow Elastomers, Wilmington, Del. 19809, USA, and believed to be a copolymer of ethylene and 1-octene. In one preferred form, the branched polyethylene does not contain repeat units derived from propylene, but does contain repeat units derived from one, two or three olefins each containing 4 or more carbon atoms, more preferably 5 or more carbon atoms.

The “branched polyethylenes” referred to in the description of this invention include ethylene/alpha-olefin copolymers. As used herein, the phrase “ethylene/alpha-olefin copolymer” refers to both heterogeneous copolymers such as linear low density polyethylene (LLDPE), very low and ultra low density polyethylene (VLDPE and ULDPE), as well as homogeneous copolymers such as linear metallocene catalyzed polymers such as EXACT® resins obtainable from the Exxon Chemical Company, and TAFMER® resins obtainable from the Mitsui Petrochemical Corporation. Ethylene/alpha-olefin copolymers include copolymers of ethylene with one or more comonomers selected from C₄ to C₁₀ alpha olefins such as butene-1, hexene-1, octene-1, etc., in which the molecules of the copolymers comprise long chains with relatively few side chain branches or cross-linked structures. Other ethylene/alpha-olefin copolymers, such as the long-chain branched homogeneous ethylene/alpha-olefin copolymers available from the Dow Chemical Company, known as AFFINITY® resins, are also included as ethylene/alpha-olefin copolymers useful for incorporation into certain film layers of the present invention.

As used herein, the phrase “heterogeneous polymer” refers to polymerization reaction products of relatively wide variation in molecular weight (M_{w}/Mₙ greater than 3.0) and relatively wide variation in composition distribution, i.e., typical polymers prepared, for example, using conventional Ziegler-Natta catalysts. Heterogeneous copolymers typically contain a relatively wide variety of main chain lengths and comonomer percentages.

As used herein, the phrase “homogeneous polymer” refers to polymerization reaction products of relatively narrow molecular weight distribution (M_{w}/Mₙ less than 3.0) and relatively narrow composition distribution. Homogeneous polymers are useful in various layers of the multilayer film used in the present invention. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene or other single-site catalysts, rather than, for example, Ziegler-Natta catalysts.

More particularly, homogeneous ethylene homopolymers and ethylene/alpha-olefin copolymers can be characterized by one or more processes known to those of skill in the art, such as molecular weight distribution, composition distribution breadth index (CDBI), and narrow melting point range and single melting point behavior. The molecular weight distribution (Mw/Mn), also known as polydispersity, or polydispersity index (“PDI”) can be determined by gel permeation chromatography.

The branched polyethylene useful in the invention generally has M_{w}/Mₙ of less than 3; preferably less than 2.7, preferably from about 1.9 to 2.5; more preferably, from about 1.9 to 2.3. The composition distribution breadth index (CDBI) of homogeneous ethylene/alpha-olefin copolymers will generally be greater than about 70 percent. The CDBI is defined as the weight percent of the copolymer molecules having a comonomer content within 50 percent (i.e., plus or minus 50%) of the median total molar comonomer content. The CDBI of linear polyethylene, which does not contain a comonomer, is defined to be 100%. The Composition Distribution Breadth Index (CDBI) is determined via the technique of Temperature Rising Elution Fractionation (TREF). CDBI distinguishes the homogeneous copolymers (narrow composition distribution as assessed by CDBI values generally above 70%) from heterogeneous copolymers such as VLDPEs that generally have a broad composition distribution, as assessed by CDBI values generally less than 55%. The CDBI of a copolymer is readily calculated from data obtained from techniques known in the art, such as, for example, temperature rising elution fractionation as described, for example, in Wild et. al., J. Poly. Sci. Poly. Phys. Ed., Vol. 20, p. 441 (1982). Preferably, branched polyethylenes useful in the processes and articles of this invention have a CDBI of from about 70% to 99%.

Branched polyethylene such as homogeneous ethylene/alpha-olefin copolymer can, in general, be prepared by the copolymerization of ethylene and any one or more alpha-olefins. Preferably, the alpha-olefin is a C₃-C₂₀ alpha-monoolefin, more preferably, a C₄-C₁₂ alpha-monoolefin, still more preferably, a C₄-C₈ alpha-monoolefin. Still more preferably, the alpha-olefin comprises at least one member selected from butene-1, hexene-l, and octene-1, i.e., 1-butene, 1-hexene, and 1-octene, respectively.

The presence of a branched polyethylene in the outer heat seal layer of the multilayer film renders the film capable of serving as a pressure-reclosable layer. The film is capable of adhesion to an adherent using light pressure at room temperature, following which the adhesive bond can be broken without leaving substantial residue on the adherent. The branched polyethylene used in the outer layer of the film is capable of serving as a pressure-reclosable seal over a broad temperature range, e.g., from as low as about −30° C. (or lower) to as high as 50° C. However, the branched polyethylenes are generally used to make pressure-reclosable seals for use at room temperature, i.e., 20° C. to 30° C. The branched polyethylene serves the same function as the first surface of the pressure-resealable closure.

In addition to being able to form a pressure-sensitive adhesive bond with itself, the branched polyethylene utilized in the present invention is also often capable of forming pressure seals with other thermoplastics, such as, for example, linear low density polyethylene (LLDPE), very low density polyethylene (VLDPE), ethylene/vinyl acetate copolymer (EVA), ionomer, and to a lesser extent, nylon, polystyrene, and polyethylene terephthalate. For the pressure-resealable closures, it is preferred that in any article which utilizes the branched polymer for forming pressure seals, that both surfaces that adhere to form the seal comprise the branched polyethylene.

In one embodiment, the branched polyethylene is a homogeneous ethylene/alpha-olefin elastomer that comprises ethylene/alpha-olefin copolymer made by metallocene-catalyzed polymerization. The metallocene-catalyzed homogeneous ethylene/alpha-olefin can comprise linear homogeneous ethylene/alpha-olefin copolymer. Alternatively, the metallocene-catalyzed homogeneous ethylene/alpha-olefin can comprise long-chain branched homogeneous ethylene/alpha olefin copolymer. The ethylene/alpha-olefin elastomer comprises a copolymer of ethylene and an alpha-olefin copolymer having from 3 to 20 carbon atoms; more preferably, an ethylene/alpha-olefin copolymer having from 3 to 8 carbon atoms.

Processes for preparing and using linear homogeneous polyolefins are disclosed in U.S. Pat. No. 5,206,075, U.S. Pat. No. 5,241,031, and PCT International Application WO 93/03093, each of which is hereby incorporated by reference thereto, in its entirety. Further details regarding the production and use of linear homogeneous ethylene/alpha-olefin copolymers are disclosed in PCT International Publication Number WO 90/03414, and PCT International Publication Number WO 93/03093, both of which are hereby incorporated by reference thereto, in their respective entireties.

Still another genus of homogeneous polyolefins is disclosed in U.S. Pat. No. 5,272,236 and U.S. Pat. No. 5,278,272, both of which are hereby incorporated by reference thereto, in their respective entireties. Each of these patents disclose “substantially linear” homogeneous long-chain branched ethylene/alpha-olefin copolymers produced and marketed by The Dow Chemical Company.

The branched polyethylene preferably is an ethylene/alpha-olefin elastomer that has a melt index of from about 0.5 grams/10 minutes to about 20 grams/10 minutes; more preferably, from about 1 to about 13 grams/10 minutes.

The molecular weight of the branched polyethylene used is not critical, although it is preferred that it be sufficiently high that the seal formed by joining the sealing surfaces is strong enough for the intended purpose. Preferably the weight average molecular weight of the polyethylene should be about 10,000 or more, more preferably about 25,000 or more, when measured by size exclusion chromatography using linear polyethylene as a standard.

In one embodiment, the present invention is directed to a multilayer film comprising:
(a) a first layer comprising a branched polyethylene having a density of up to about 0.875 g/cc, said first layer being an outer layer that is hermetically heat-sealable and pressure-reclosable; and
(b) a second layer comprising a different thermoplastic polymer.

As used herein, the phrase “outer layer” refers to any film layer of film having less than two of its principal surfaces directly adhered to another layer of the film. The phrase is inclusive of monolayer and multilayer films. In multilayer films, there are two outer layers, each of which has a principal surface adhered to only one other layer of the multilayer film. In monolayer films, there is only one layer, which, of course, is an outer layer in that neither of its two principal surfaces are adhered to another layer of the film.

As used herein, the phrase “pressure-reclosable layer” refers to a film layer that develops an adhesive bond to itself or to other surfaces at room temperature, by applying only a moderate pressure (e.g., 0.5-50 psi for one second at 30° C. or room temperature). Such as bond is also referred to herein as a pressure-induced bond. Such behavior is referred to as a pressure-induced seal, a pressure-induced bond, or a cold seal.

As used herein, the term “seal” refers to any seal of a first region of an outer film surface to a second region of an outer film surface, including heat-seals as well as pressure induced seals made at a temperature of less than 40° C. In contrast, the phrase “heat seal” refers to seals made by heating one or more polymeric components in one or more films to at least 40° C., so long as 40° C. is at or above the heat seal initiation temperature of enough of the polymer of the layer that polymer melts and resolidifies at room temperature to form a hermetic seal. Heat-sealing can be performed by any one or more of a wide variety of manners, such as using a heat-seal technique (e.g., melt-bead sealing, thermal sealing, impulse sealing, ultrasonic sealing, hot air, hot wire, infrared radiation, etc.). A preferred sealing method uses the same double seal bar apparatus used to make the pressure induced seal in the examples herein. Another preferred sealing method is impulse heat sealing, utilizing seal wire of a material known as Toss Alloy 20, obtained from Toss Machine Components of Nazareth, Pa. In making the heat-seal, the total dwell time is typically about 2 seconds; however, shorter seal times are possible.

As used herein, the term “hermetic seal” refers to both peelable and unpeelable seals, which do not permit the flow (as opposed to diffusion) of fluid, especially a gas such as air, and/or a liquid such as water.

As used herein, the phrases “seal layer,” “sealing layer,” “heat-seal layer,” and “sealant layer,” refer to an outer film layer, or layers, involved in the pressure-induced sealing and/or heat-sealing of the film to itself, to another film layer of the same or another film, and/or to another article which is not a film.

Although the film made from the branched polyethylenes can be a monolayer film laminated or extrusion-coated to at least one other film layer to form a multilayer film, in one preferred embodiment, the multilayer film is a coextruded film having branched polyethylene (e.g., an ethylene/alpha-olefin copolymer) present in one or more of the outer layers of the film.

Preferably, a multilayer film according to the present invention comprises a total of from 2 to 20 layers; more preferably, from 2 to 12 layers; more preferably, from 2 to 9 layers; more preferably, from 3 to 8 layers. Various combinations of layers can be used in the formation of a multilayer film according to the present invention. Given below are some examples of preferred multilayer film structures in which letters are used to represent film layers (although only 2- through 5-layer embodiments are provided here for illustrative purposes, further layers could be present):

A/B, A/C,
A/B/A, A/B/B′, A/B/C,
A/B/CB, AB/CB′,
A/B/C/B/A, B/A/C/B/A
B/A′/CB/A

wherein

A represents a layer that includes the branched polyethylene described above, alone or in a blend with another polymer, particularly an ethylene/alpha-olefin copolymer having a density up to about 0.875 g/cc.

B represents a layer including at least one member selected from polyolefin (particularly an ethylene/alpha-olefin copolymer), polyester (including polycarbonate), polyamide, polyaromatic (particularly polystyrene), poly(phenol-formaldehyde), and poly(amine-formaldehyde)), polyether, polyimide, polyimine, polyurethane, polysulfone, polyalkyne and ionomer; and

C represents a layer including a polymer serving as an oxygen barrier layer, e.g., polyvinylidene chloride “PVDC” (PVDC homopolymer and/or methyl acrylate copolymer “PVDC-MA” and/or vinyl chloride copolymer “PVDC-VC”), ethylene/vinyl alcohol copolymer (“EVOH”), polyamide, etc.

As required, one or more tie layers can be used between any one or more layers of in any of the above multilayer film structures. Also, while “A” is a branched polyethylene in the above structures, “A′” is a different branched polyethylene, and so on, whereas a film having two “B” layers (as opposed to B and B′) could have the same B polymer(s) or different B polymer(s), in the same or different amounts and/or ratios with respect to one another and with respect to the multilayer film as a whole.

As used herein, the term “barrier”, and the phrase “barrier layer”, as applied to films and/or film layers, are used with reference to the ability of a film or film layer to serve as a barrier to the passage of one or more gases. In the packaging art, selective oxygen (i.e., gaseous O₂) barrier layers have included, for example, hydrolyzed ethylene/vinyl acetate copolymer (designated by the abbreviations “EVOH” and “HEVA”, and also referred to as “ethylene/vinyl alcohol copolymer”), polyvinylidene chloride (“PVDC”), especially PVDC-methyl acrylate copolymer (“PVDC-MA”), and PVDC-vinyl chloride copolymer (“PVDC-VC”), as well as polyamide, polyester, polyalkylene carbonate, polyacrylonitrile, etc., as known to those of skill in the art.

In general, the multilayer film(s) used in the present invention can have any total thickness desired, so long as the film provides the desired properties for the particular packaging operation in which the film is used, e.g. abuse-resistance (especially puncture resistance), modulus, seal strength, optics, etc. Preferably, the film has a total thickness of less than about 50 mils, more preferably the film has a total thickness of from about 0.2 to 20 mils, more preferably 1 to 10 mils, more preferably 1 to 8 mils, more preferably 1 to 6 mils, more preferably 1.5 to 5 mils.

The multilayer film of this invention is capable of forming a pressure-induced reclosable seal having a seal strength of at least 50 grams per centimeter for at least two repetitions when the first layer of the film is subjected to a 40 psi seal for one second at 30° C. Preferably, the pressure-induced reclose seal strength is from 50 to 600 grams per centimeter, more preferably from 70 to 400 grams per centimeter, and more preferably from 90 to 350 grams per centimeter.

At least one preferred embodiment of the invention has been found to be capable of adhering to itself repeatedly through many cycles of pressure-induced sealing followed by being pulled apart, with the adhesive character maintaining an adhesive bond sufficient to afford a pressure-reclosable feature to the packaging. The pressure-reclosability is capable of providing from 2 to 250 pressure-reclose cycles; typically from 4 to 100 cycles, and still more typically from 4 to 25 pressure-reclose cycles.

In one preferred embodiment of the present invention, the branched polyetheylene is the outer layer of a multilayer film. This outer, branched polyethylene layer allows the film to adhere to other surfaces, such as itself or other thermoplastic layers. As used herein, the term “film” is used in a generic sense to include plastic web, regardless of whether it is film or sheet, and whether it has been reshaped to a geometry which is no longer planar. Preferably, films of and used in the present invention have a (total) thickness of 0.25 mm or less.

In a preferred embodiment, at least one outer layer of the film contains branched polyethylene which can be present at a level of up to 100 percent of the weight of the film layer. The branched polyethylene can be blended with one or more additional polymers and/or additives (such a slip agents, antiblock agents, etc). If another polymer is present in the first layer, the branched polyethylene preferably comprises at least about 30% of the weight of the layer, more preferably at least about 50%, more preferably at least about 60%, more preferably at least about 70%, more preferably at least about 90%. Preferably, the branched polyethylene comprises a homogeneous ethylene/alpha-olefin copolymer having a density of up to about 0.875 g/cc.

Preferably, the outer seal layer and the second layer are coextruded. Alternatively, the seal layer and the second layer are extrusion-coated, laminated, or spray-coated. Alternatively, the film can be produced using a lamination process. Optionally, the multilayer film can comprise an O₂-barrier layer.

Preferably, the branched polyethylene is present in the outer heat-seal layer in an amount of at least 20 weight percent, based on total layer weight; more preferably, from 30 to 100 weight percent; more preferably from 50 to 100; more preferably from 70 to 100; more preferably from 90 to 100 weight percent.

The second layer is a thermoplastic, and preferably comprises at least one member selected from; olefin homopolymer, olefin copolymer, polyamide, polyester, ethylene/vinyl alcohol copolymer, halogenated polymer, polystyrene, styrene/butadiene copolymer, polynorbornene, and ethylene/unsaturated ester copolymer. If an olefin copolymer, preferably the second layer comprises at least one member selected from: ethylene/alpha-olefin copolymer, linear low density polyethylene, very low density polyethylene, high density polyethylene, and low density polyethylene. If ethylene/unsaturated ester copolymer, preferably the second layer comprises at least one member selected from: ethylene/vinyl acetate copolymer, ethylene/butyl acrylate copolymer, and ethylene/unsaturated acid polymer, such as ethylene acrylic acid copolymer and ethylene/methacrylic acid copolymer.

By “thermoplastic” is meant any polymer that has a melting point or, if no such melting point is present, a glass transition temperature of 30° C. or more. Preferably the melting point has a heat of fusion associated with it of about 3 J/g or more. Melting points and glass transition temperatures are measured by ASTM Method D3418. Melting points are taken as the maximum of the melting endotherm, and are measured on the second heat. Also included within the definition of thermoplastic herein is any branched polyethylene with a density of about 0.875 or less which comprises a sealing surface.

Multilayer films containing the branched polyethylene can be heat-shrinkable. As used herein, the phrases “heat-shrinkable,” “heat-shrink” and the like refer to the tendency of a film, generally an oriented film, to shrink upon the application of heat, i.e., to contract upon being heated, such that the size (area) of the film decreases while the film is in an unrestrained state. Likewise, the tension of a heat-shrinkable film increases upon the application of heat if the film is restrained from shrinking. As a corollary, the phrase “heat-contracted” refers to a heat-shrinkable film, or a portion thereof, which has been exposed to heat such that the film or portion thereof is in a heat-shrunken state, i. e., reduced in size (unrestrained) or under increased tension (restrained).

In one embodiment, the multilayer film has a total free shrink, at 185° F., of from about 15 to 150 percent; more preferably, from 15 to 150 percent; more preferably, from 20 to 120 percent; more preferably, from 20 to 100 percent. In another embodiment, the multilayer film has a total free shrink, at 185° F., of from 0 to 10 percent; more preferably, from 2 to 10 percent.

As used herein, the phrase “free shrink” refers to the percent dimensional change in a 10 cm×10 cm specimen of film, when shrunk at 185° F., with the quantitative determination being carried out according to ASTM D 2732, as set forth in the 1990 Annual Book of ASTM Standards, Vol. 08.02, pp. 368-371, which is hereby incorporated, in its entirety, by reference thereto. Preferably, the heat shrinkable film has a total free shrink (i.e., machine direction plus transverse direction), as measured by ASTM D 2732, of at least as 10 percent at 185° F., for example at least 15 percent, at least 20 percent, from 30 to 150 percent, from 30 to 120 percent, from 40 to 110 percent, from 50 to 100 percent, from 60 to 100 percent, or from 70 to 95 percent, at 185° F.

As used herein, the phrase “machine direction”, herein abbreviated “MD”, refers to a direction “along the length” of the film, i.e., in the direction of the film as the film is formed during extrusion and/or coating. As used herein, the phrase “transverse direction”, herein abbreviated “TD”, refers to a direction across the film, perpendicular to the machine or longitudinal direction.

Optionally, at least one member selected from the first layer and the second layer comprises at least one member selected from the group consisting of slip agent and antiblock agent. Optionally, the first layer comprises at least one member selected from: slip agents and antiblock agents.

In one embodiment, a branched polyethylene makes up 100 weight percent of the first layer.

A branched polyethylene that can be used in the multilayer film is an ethylene/alpha-olefin copolymer elastomer that has an ethylene mer content which is at least 50 mole percent, more preferably from about 60 to 95 mole percent, or 75 to 90 mole percent. Preferably, the ethylene/alpha-olefin elastomer has a melt index of from about 0.5 to 20 grams per 10 minutes, more preferably from about 1 to 15 grams per 10 minutes.

In one embodiment, the first layer comprises a blend containing (A) from about 15 to 99 percent, based on layer weight, of a branched polyethylene having a density of up to about 0.875 g/cc; and (B) from about 1 to about 85 percent, based on layer weight, of at least one polymer selected from an olefin homopolymer having a density of at least 0.88 g/cc and an olefin copolymer having a density of at least 0.88 g/cc. Preferably, the branched polyethylene is present in the blend in an amount of from about 30 to about 99 weight percent and the olefin homo- or co-polymer is present in an amount of from about 1 to 70 weight percent; more preferably the branched polyethylene in an amount of from 50 to 99 weight percent and the other polymer in an amount of from about 1 to 50 weight percent, more preferably the branched polyethylene in an amount of from 60 to 99 weight percent and the other polymer in an amount of from about 1 to 40 weight percent, more preferably the branched polyethylene in an amount of from 70 to 99 weight percent and the other polymer in an amount of from about 1 to 30 weight percent, more preferably the branched polyethylene in an amount of from 90 to 99 weight percent and the other polymer in an amount of from about 1 to 10 weight percent.

The present invention is also directed to a hermetically heat-sealable, pressure-reclosable multilayer film comprising: (A) a first layer which is an outer film layer and which comprises a branched polyethylene having a density of up to about 0.875 g/cc; and (B) a second layer which is an outer, heat-resistant layer comprising a thermoplastic polyolefin having DSC melting point or glass transition temperature of at least about 100° C., at least one of outer layer (A) and (B) having a coefficient of friction of less than 0.5 as measured by ASTM D 1894. This relatively low coefficient of friction can be obtained by incorporating a slip agent and/or an antiblock agent into the layer containing the branched polyethylene or the thermoplastic polyolefin.

The multilayer film can have various additional layers including one or more barrier layers, tie layers, abuse layers, bulk layers, modulus layers, abrasion resistant layers, heat-resistant layers, etc. These layers can contain one or more of the various polymers defined herein. In such a multilayer film, the other layers can provide one or more other physical attributes such as tensile strength, tear resistance, lowered diffusion of various materials into and/or out of a package, printability, and color (for example a pigmented layer). Single or multilayer films are useful for forming many forms of packaging, such as bags.

Regardless of the structure of the multilayer film, one or more conventional packaging film additives can be included therein. Examples of additives that can be incorporated include, but are not limited to, antiblocking agents, antifogging agents, slip agents, colorants, flavorings, antimicrobial agents, meat preservatives, and the like. Where the multilayer film is to be processed at high speeds, inclusion of one or more antiblocking agents in and/or on one or both outer layers of the film structure can be provided. Examples of useful antiblocking agents for certain applications are corn starch and ceramic microspheres.

In another preferred form, in a film one of the outside layers comprises the branched polyethylene, but this layer does not extend over the entire surface of the film. Rather the branched polyethylene-containing layer is present over only part of the overall surface of the film, for example as strips. These strips can be “more permanently” bonded to the rest of the film by heat-sealing, an adhesive, etc. The film can then be formed, for example, into a side seal bag where the strips are on opposite inside surfaces of the bag at the opening of the bag. The bag can then be opened by pulling apart the film to which the strips are attached, and resealed by applying pressure to the strips while they are contacting one another. Other configurations of bags and other packaging where the sealing surfaces do not cover the entire surface of the film will be apparent to the artisan.

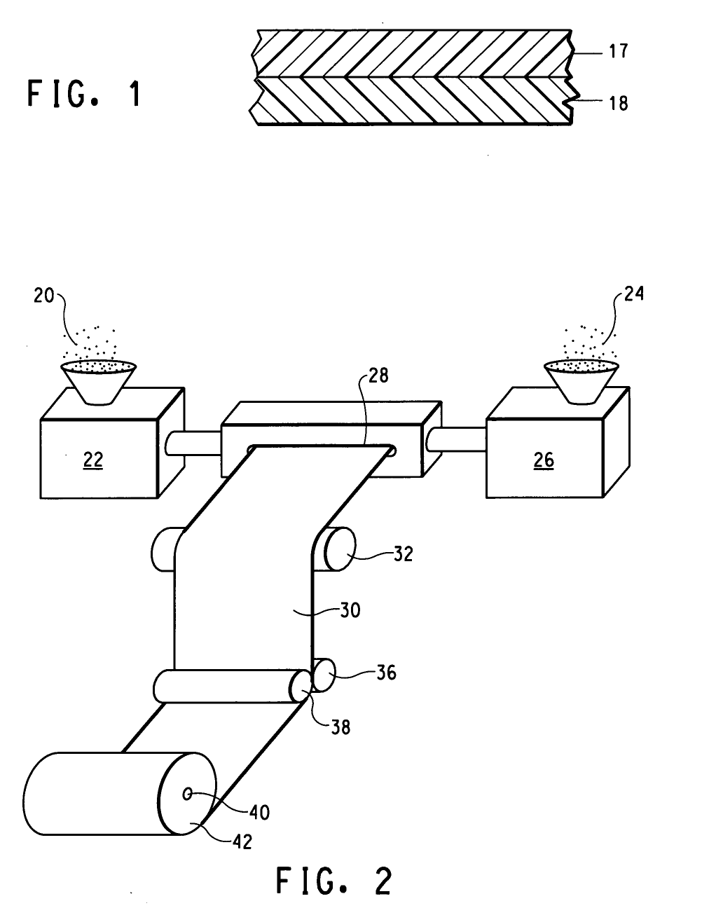

FIG. 1 illustrates an enlarged, schematic cross-sectional view of two-layer film 16 for use in the present invention. Two-layer film 16 contains first layer 17 and second layer 18, both of which are outer film layers. First layer 17 is a heat-sealable, pressure-reclosable layer, and second layer 18 contains a different polymeric composition from the polymeric composition of first layer 17.

The production of single and multilayer films, and other types of items comprising the present branched polyethylenes, including packages or various types, is well known in the art, and is disclosed, for example, in World Patent Application 03/039866, which is hereby incorporated herein by reference.

The heat-sealable, pressure-reclosable film suitable for use in the present invention can be produced by the process illustrated in FIG. 2. In FIG. 2, polymer pellets 20 of a first polymer are fed into first extruder 22 and polymer pellets 24 of a second polymer are fed into and through second extruder 26. While in extruders 22 and 26, pellets 20 and 24 are subjected to heat and shear, and are consequently melted and degassed so that a molten polymer stream emerges from extruders 22 and 26. The molten polymer streams are fed into slot die 28, with the streams emerging from slot die 28 as a molten two-layer cast film 30. Shortly after emerging from slot die 28, molten two-layer cast film 30 is quenched before or during contact with first roller 32 (which optionally can be cooled), with cast film 30 solidifying while on roller 32, and with cast film 30 making a partial wrap around roller 32. The now solidified cast film 32 is forwarded off of roller 32 and into nip 34 between nip rollers 36 and 38, which serves to forward cast film 30 and to maintain tension on cast film 30 downstream of first roller 32. Thereafter, cast film 30 makes a partial wrap around nip roller 38, and is thereafter wound onto core 40 to result in a film roll 42.

Alternatively, an annular die can be used to make a film suitable for use in the process of the present invention. Quenching of the molten extrudate emerging from the die can be accomplished with cascading water or by casting directly into a cooled water bath. Although a simple cast film can be produced in this manner, on the other hand, a film suitable for use in the process of the present invention can be produced using a sequential casting, quenching, reheating, and orientation process. The film can be cast from an annular (or slot) die with the extrudate being quenched to cause cooling and solidification, followed by being reheated to a temperature below the melt point (preferably to the softening point of the film), followed by solid-state orientation using a tenter frame (i.e., for a flat film extruded through a slot die) or using a trapped bubble (i.e., for an tubular film extruded through an annular die). The annular extrudate, commonly called a “tape”, can be quenched using cascading water, cooled air (or other gas), or even ambient air. The resulting solidified and cooled tape is then reheated to a desired orientation temperature and oriented while in the solid state, using for example, a trapped bubble. Films that are oriented in the solid state are considered to be heat-shrinkable, as they have a total free shrink (L+T) at 185° F. of greater than 10 percent.

The multilayer film can also be prepared using a lamination process or an extrusion coating process.

Alternatively, the heat-sealable, pressure-reclosable films suitable for use in the process of the present invention can be produced using a hot blown process in which the film is extruded through an annular die and immediately hot-blown by a forced air bubble, while the polymer is at or near its melt temperature. Such hot blown films exhibit a total (i.e., longitudinal plus transverse) free shrink at 185° F. of less than 10 percent, generally no more than 5 percent in either direction. Such hot-blown films are not considered to be heat-shrinkable films because the amount of heat-shrinkability is not high enough to provide the advantageous shrink character typically required of heat-shrinkable films. Although hot-blown films are oriented, the orientation occurs in the molten state, without producing the orientation-induced stress recognized in the art as that which renders the film heat-shrinkable.

As is known to those of skill in the art, various polymer modifiers can be incorporated into certain film layers for the purpose of improving toughness and/or orientability or extensibility of the multilayer film. Modifiers which can be added to certain layers within the films of the present invention include: modifiers which improve low temperature toughness or impact strength, and modifiers which reduce modulus or stiffness. Exemplary modifiers include: styrene-butadiene, styrene-isoprene, and ethylene-propylene.

The multilayer film can be used for the preparation of a wide variety of packaging articles, including bags, pouches, or casings, vacuum skin packaging, form-fill-and-seal packages (i.e., “FFS” processes, including both horizontal FFS and vertical FFS), etc. The casings can be seamless or backseamed, and if backseamed, can be fin-sealed, lap-sealed, or butt-sealed with a backseam tape. The bags can be end-seal, side-seal, or L-seal. A U-sealed packaging article is considered to be a pouch.

The present invention also pertains to a packaging article comprising a multilayer film having a first layer and a second layer, the first layer being an inside layer of the article, the first layer comprising a branched polyethylene having a density of up to about 0.875 g/cc, the second layer comprising a different thermoplastic polymer, with the inside layer heat-sealed to itself or another component of the packaging article, and the inside layer being hermetically heat-sealable and pressure-reclosable to itself or the other component of the packaging article.

As used herein, the term “packaging article” includes bags, pouches, casings, trays and other thermoformed articles, etc., that are useful for packaging one or more products.

As used herein, the terms “inner layer” and “internal layer” refer to any layer, of a multilayer film, having both of its principal surfaces directly adhered to another layer of the multilayer film.

As used herein, the term “inside layer” refers to the outer layer of a multilayer packaging film, which is closest to the product cavity, relative to the other layers of the multilayer film. In one embodiment, the inside layer is the pressure-reclosable layer capable of forming a pressure-induced bond.

In one embodiment, the packaging article is a bag and the inside layer is hermetically heat sealed to itself. Alternatively, the multilayer film can be heat sealed to a second component that is molded or thermoformed.

As used herein, the term “bag” is inclusive of L-seal bags, side-seal bags, end-seal bags, backseamed bags, and pouches. An L-seal bag has an open top, a bottom seal, a seal along a first side edge, and a seamless (i.e., folded, unsealed) second side edge. A side-seal bag has an open top and a seamless bottom edge, with each of its two side edges having a seal therealong. An end-seal bag is made from seamless tubing and has an open top, a bottom seal, and seamless side edges. A pouch has an open top and a bottom seal and a seal along each side edge. Although seals along the side and/or bottom edges can be at the very edge itself, (i. e., seals of a type commonly referred to as “trim seals”), preferably the seals are spaced inward (preferably about 0.6 to about 1.3 cm) from the bag side edges, and/or preferably are made using impulse-type heat sealing apparatus, which utilizes a bar which is quickly heated and then quickly cooled. A backseamed bag is a bag having an open top, a “backseam seal” running the length of the bag in which the bag film is either fin-sealed or lap-sealed, two seamless side edges, and a bottom seal along a bottom edge of the bag.

The present invention is also directed to a process for making a sealed article, comprising: (A) providing a multilayer film having a first layer that is a heat-sealable, pressure-reclosable layer and that comprises a branched polyethylene having a density of up to about 0.875 g/cc; and (B) heat sealing the first layer of the multilayer film to itself or another article by heating the first layer to a temperature of at least 50° C.

The present invention is also directed to a package comprising a tray having a lidding film adhered thereto, the tray having a support member, upwardly extending walls, and a flange above the upwardly extending walls, with the lidding film being a multilayer film having a first layer and a second layer, the first layer being an inside heat-sealable, pressure-reclosable layer comprising a branched polyethylene having a density of up to about 0.875 g/cc, the second layer comprising a different thermoplastic polymer. Preferably, the tray comprises a rigid member to which a flexible film is adhered, with the flexible film comprising an O₂-barrier layer and the lidding film also comprising an O₂-barrier layer.

As used herein, the term “package” refers to packaging materials configured around (i.e., enveloping) a product being packaged. The phrase “packaged product,” as used herein, refers to the combination of a product that is surrounded or substantially surrounded by a packaging material.

Another form of packaging in which the branched polyethylene is useful when it comprises a pressure-resealing surface is “vacuum skin packaging”. As used herein, the term “vacuum skin packaging” refers to a topographic heat seal, as contrasted to a perimeter heat seals. In forming a topographic seal, the surfaces of two films are brought into contact with one another, for example by using differential air pressure. The films contour about a product and hermetically bond to one another throughout the region(s) of film-to-film contact. Branched polyethylenes, especially ethylene/alpha-olefin elastomers, are especially well-suited to the topographic seals employed in vacuum skin packaging. Vacuum skin packaging is described in US Patent RE 030009, which is hereby incorporated by reference.

Other useful types and configurations of packaging, including those employing single layer and multilayer films will be found in World Patent Application 03/039866.

This invention provides an article having a pressure resealable closure, comprising a first resealable surface and a second resealable surface, wherein a first material of said first resealable surface comprises a branched polyethylene having a density of up to about 0.875 g/cc and a second material of said second sealing surface comprises a thermoplastic.

By “sealable surfaces” is meant surfaces that when contacted with each other under pressure adhere to one another to form a substantially hermetic seal.

By a “closure” is meant that part of an article that has two sealing surfaces that adhere to each other by pressure sealing. The closure may be the only opening in the article, but it does not have to be.

By a “pressure-resealable closure” means an aperture that is closed by the application of pressure, and optionally heat, to the sealing surfaces. Preferably, heat is not applied. These sealing surfaces can then be pulled apart to reopen the closure, and the sealing surfaces can then be resealed by application of pressure. Although higher pressures can be applied by a pressure-generating apparatus (such as a press), or between a roller and a solid surface, or between two rollers, preferably the pressure is that generated by hand, as by squeezing the sealing surfaces between fingers or palms (or a pressure of about 30 kPa to about 140 kPa), or against a solid surface by hand. Preferably this sealing is done at ambient temperatures, more preferably about 0° C. to about 40° C., and especially preferably about 10° C. to about 35° C.

A preferred branched polyethylene has one, two or three branches, and can conveniently be made by copolymerizing ethylene with one, two or three other olefins, preferably α-olefins of the formula H₂C═CHR¹, wherein R¹ is alkyl, more preferably α-olefins of the formula H₂C═CH(CH₂)ₙH, wherein n is an integer of 1 to 30, more preferably n is an integer of 2 to 25, and especially preferably n is an integer of 4 to 20. Preferably ethylene is copolymerized with two other olefins, more preferably with one other olefin. When three other olefins are copolymerized the polyethylene has branches with three different lengths, when two other olefins are copolymerized the polyethylene has branches with two different lengths, and when one other olefin is copolymerized the polyethylene has branches with a single lengths, when the polymerization catalyst used is not a chain-walking catalyst.

The branched polyethylenes having one, two or three branches are most conveniently made by using a non-chain walking catalyst as the polymerization catalyst, such as a Ziegler-Natta-type catalyst or a metallocene-type catalyst, preferably a metallocene catalyst. Such polymerization catalysts are known in the art and are disclosed, for example, in Angew. Chem., Int. Ed. Engl., vol. 34, p. 1143-1170 (1995), European Patent Application 416,815 and U.S. Pat. No. 5,198,401 for information about metallocene-type catalysts, and J. Boor Jr., Ziegler-Natta Catalysts and Polymerizations, Academic Press, New York, 1979 for information about Ziegler-Natta-type catalysts, all of which are hereby incorporated herein by reference. When these types of polymerization catalysts are used, the incorporation of α-olefin H₂C═CHR¹ usually results in an —R¹ branch in the PE, while the α-olefin H₂C═CH(CH₂)ₙH usually results in a —(CH₂)ₙH branch ion the PE.

The branched polyethylene used herein that has only branches of the formula —(CH₂CH₂)ₘH, wherein m is an integer of one or more, can be made using non-chain walking polymerization catalysts by adding at least three α-olefins of the formula H₂C═CH(CH₂CH₂)ₘH to the ethylene copolymerization and using a polymerization catalyst which can copolymerize these α-olefins with ethylene. Alternatively, this branched polyethylene can be made by methods described in U.S. Pat. No. 6,297,338 (which is hereby incorporated herein by reference), wherein an oligomerization catalyst oligomerizes ethylene to a mixture of α-olefins and an ethylene copolymerization catalyst then copolymerizes ethylene with the mixture of α-olefins that has been formed. In this branched polyethylene, it is preferred that m is 2 or more.

The amounts and lengths of branches can be measured by ¹³C-NMR, as disclosed, for example, in World Patent Application 96/23010 and 03/044066, both of which are hereby incorporated herein by reference. Branches longer than C₅ can be measured by similar methods but using higher field NMR machines. Correction can be made for end groups (by subtraction from the total branching measured). As a first approximation when using nonchain walking polymerization catalysts, the lengths of branches in a polyethylene copolymer should be those from “normal” polymerization of the comonomer olefins added or reasonably expected to be present. For example, 1-butene would be expected to give ethyl groups, while 1-octene would be expected to give n-hexyl groups.

By a “branch length” is meant the number of carbon atoms in a branch on the main chain of the polymer. For example the branch length of methyl is 1, ethyl is 2, isopropyl or n-propyl are 3, n-butyl or iso-butyl are 4, n-pentyl is 5, n-hexyl is 6, and n-octyl is 8. Not included in “branches” are end groups of the polyolefin, and in particular if the molecular weight of the polyolefin is relatively low, the branching level should be corrected for end groups. Also not included in branches of a given branch length are so-called long-chain branches which occur at frequencies of less than 1 branch per 1000 methylene groups in the polymer.

Useful ethylene copolymers also include copolymers having a density of up to about 0.875 and having one or more different branch lengths, so long as methyl branches are not present (excluding end groups).

The branched polyethylene can be blended with one or more other polymers to form the composition of the sealing surface. In this instance the sealing surface preferably comprises about 20 to about 95 percent by weight, based on the total amount of polymers in the composition, of branched polyethylene. A preferred polymer for blending is a polyethylene having a density of more than 0.865 g/cc, more preferably more than 0.87 g/cc, and especially preferably about 0.88 g/cc to about 0.93 g/cc. Generally speaking the greater the proportion of higher density polyethylene (or other thermoplastic) used, and/or the higher the density of the higher density polyethylene, the more pressure will be required to adhere the pressure-resealable surfaces to each other, but often a higher adhesion between the surfaces will be obtained.

The branched polyethylenes described herein can form sealing surfaces on any appropriate type of packaging, including the types specifically described herein. Such packaging in turn can be part of a packaged product, utilizing these packages to contain a product. Products that can be packaged therein include, for example, food, drink, chemicals, mechanical equipment, electrical or electronic equipment, and batteries.

The phrases “pressure-induced bond” and “pressure-induced seal” are used herein interchangeably, and are considered to be equivalent in meaning.

### EXAMPLES

### Example 1

A two-layer film was coextruded on a Randcastle Extrusion System laboratory scale extruder, model RC 0625, having a 6-inch slot die and utilizing two extruders. Upon emerging from the slot die, the extrudate was deposited onto a first roller, with the extrudate making a partial wrap around the first roller and then passing through a set of nip rollers and then was wound up to form a roll, in the process illustrated in FIG. 2 (described above). The first roller was not chilled, but rather was allowed to equilibrate to a temperature between the ambient environment and the temperature of the extrudate. Whether the first layer emerged from the die on top of the second layer (i.e., with the second layer coming into direct contact with the first roller), or beneath the second layer (i.e., with the first layer coming into direct contact with the first roller), was found to make substantially no difference in the properties of the resulting film.

The first film layer of the film was 100 weight percent ENGAGE® 8100 homogeneous ethylene/octene copolymer having a density of 0.870 g/cc, a melt flow index of 1.0 decigram/minute, obtained from DuPont-Dow Elastomers. The second film layer was 100 weight percent Fortiflex® T60-500-119 high density polyethylene having a density of 0.961 gm/cc and a melt index of 6.0 decigrams/minute, obtained from BP Chemicals. Each of the two layers had a thickness of 2 mils, with the two layer film having a total thickness of 4 mils.

After the two-layer, 4-mil multilayer film was extruded and wound up, it was allowed to age at least 30 minutes before 36 film strips were cut from the film for seal strength testing. Twelve one-inch wide, ten-inch long strips of the multilayer film were cut from the extruded multilayer film made on the Randcastle Extrusion System laboratory scale extruder. The length of each of the strips corresponded with the machine direction of the extruded multilayer film, with the width of the film strip corresponding to the transverse direction of the multilayer film. The film strips were taken from the central region of the multilayer film, which had a total width of about 5.5 inches. The central 3 inches of the 5.5 inch wide film provided three film strips each one inch wide.

The heat seal layers (i.e., the first layer) of the strips of film were heat-sealed transversely to one another to form sealed pairs of strips.

The pressure-induced seals and the heat seals were made using a Sencorp Double Bar Sealer, Model No. 128SL/I, using ⅜-inch wide seal bars (one above the film strips, the other below the film strips), to seal two strips together across their width. Both the upper seal bar and the lower seal bar were heated to the specified temperature (i.e., 30° C., 50° C., 70° C., 90° C., 110° C., or 130° C.) to make the heat seal. (The seal made at 30° C. is not considered to be a “heat” seal, but rather is considered to be a pressure—induced seal. However, the seals made at 50° C., 70° C., 90° C., 110° C., or 130° C. are considered to be heat seals.) The resulting heat seal had a length of one inch (i.e., the one-inch width of the overlapping film strips) and a width of 0.375 inch (i.e., the width of the seal bars). The overlapping strips of film were contacted by the upper and lower seal bars for a dwell time of 1 second, with the overlapping film strips being subjected to a pressure of 40 psi between the seal bars. The resulting heat-seal had a total area of 0.375 square inch.

After the film strips were heat-sealed to one another, the resulting pairs of film strips, which were sealed together, were allowed to age for at least 30 minutes before the seal strength was measured. Seal strength was measured using ASTM F88, e.g., with an Instron® Mini 55® instrument, using a 100 pound load cell, with the seal strength results being reported as maximum load in the units of pounds force per inch, i.e., lbf/in. The Mini 55 machine pulled the strips apart at the heat seal during the measurement of the strength of the heat-seal.

For the heat-seal testing of the film, different film strips pairs taken from the same multilayer film were heat-sealed together at each of the following temperatures: 30° C., 50° C., 70° C., 90° C., 110° C., and 130° C., with sealing beginning at 30° C. and progressing on up through 130° C. After each seal was made, the resulting sealed-together pair of film strips was aged for at least 30 minutes before seal strength testing was conducted. During seal strength testing, the sealed-together pair of film strips was pulled apart.

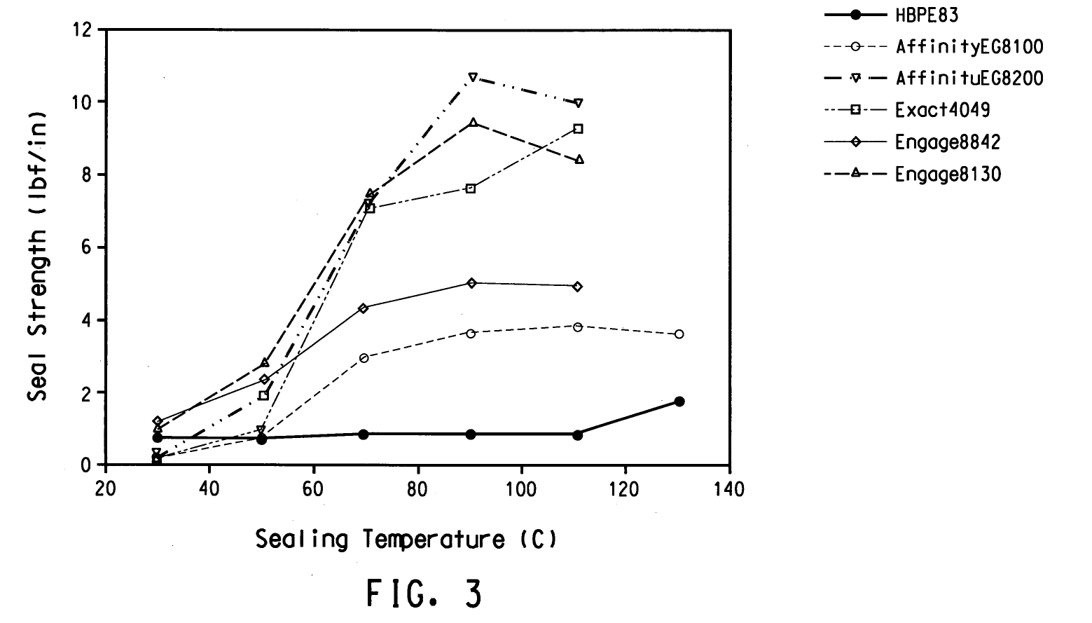

Several pairs of film strips were sealed together and tested for seal strength at each temperature, with the results averaged to provide the values set forth in FIG. 3. All of the film strips of Example 1 had low seal initiation temperature and formed strong hermetic seals within the seal temperature range of 70° C. to 110° C. The heat-seal could be pulled apart and the film could be pressure reclosed (i.e., pressure resealed) at any location on the sealant layers of each of the pairs of strips.

Pressure-induced reclose seals were made also using two 1-inch wide by 10-inch long film strips which were cut from the extruded film as in the heat-seal testing, described above. The first layer of each of the film strips was pressed together to form a pressure-induced reclosable seal. This was accomplished by again using the Sencorp Double Bar Sealer, Model No. 128SL/I, with 40 psi pressure being applied for one second to make the pressure-induced seal, with both seal bars being at 30° C. The resulting pressure-induced seal was allowed to age at room temperature for at least 30 minutes before the seal strength was measured on using the procedure of ASTM F88, e.g., using an Instron Mini 55 instrument.

During the measurement of the seal strength of the first pressure-induced reclose seal for the pair of film strips, the strips were pulled apart by the measuring device. After the seal strength test was completed and the film strips completely separated from one another, the film strips were again inserted into the Sencorp Double Bar Sealer, and the same areas of the film strips were again subjected to 40 psi for one second with the seal bars being at 30° C., to make another pressure-induced reclose seal at the same location of the same two film strips. The strength of this second pressure-induced reclose seal was then measured using ASTM F88, i.e., just as in the measurement of the strength of the first pressure-induced reclose seal.

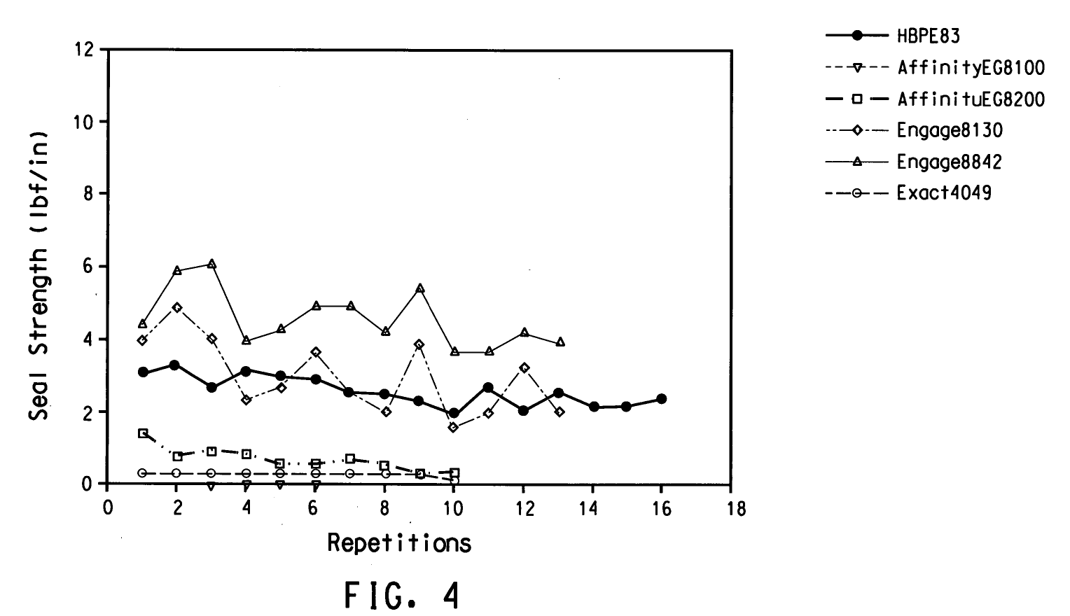

This process of making the pressure-induced reclose seal, as well as the method of testing the strength of the pressure-induced reclose seal, was repeated ten times for each pair of film strips tested. FIG. 4 provides the seal strength results for the repeated pressure-induced reclose seal of the film of Example 1, as well as Examples 2-5, described below.

### Example 2

A second two-layer film was coextruded and tested for seal strength in the same manner as in Example 1. However, instead of the first layer being 100 weight percent ENGAGE® 8100 ethylene/octene copolymer, the first layer was 100 weight percent ENGAGE® 8200 ethylene/octene copolymer having a density of 0.870 g/cc, and a melt flow index of 5.0 decigram/minute, also obtained from DuPont-Dow. The heat-seal strength results of Example 2, and the pressure-induced reclosable seal strength results for Example 2, are provided in FIG. 3 and FIG. 4, respectively, with the resin utilized and the pressure-induced reclosable seal strength results being summarized in Table I, below.

### Example 3

A third two-layer film was coextruded and tested for seal strength in the same manner as in Example 1. However, instead of the first layer being 100 weight percent ENGAGE® 8100 ethylene/octene copolymer, the first layer was 100 weight percent ENGAGE® 8130 ethylene/octene copolymer having a density of 0.864 g/cc, and a melt flow index of 13.0 decigram/minute, also obtained from DuPont-Dow. The heat seal strength results of Example 3, and the pressure-induced reclosable seal strength results for Example 3, are provided in FIG. 3 and FIG. 4, respectively, with the resin utilized and the pressure-induced reclosable seal strength results being summarized in Table I, below.

### Example 4

A fourth two-layer film was coextruded and tested for seal strength in the same manner as in Example 1. However, instead of the first layer being 100 weight percent ENGAGE® 8100 ethylene/octene copolymer, the first layer was 100 weight percent ENGAGE® 8842 ethylene/octene copolymer having a density of 0.857 g/cc, and a melt flow index of 1.0 decigram/minute, also obtained from DuPont-Dow. The heat seal strength results of Example 4, and the pressure-induced reclosable seal strength results for Example 4, are provided in FIG. 3 and FIG. 4, respectively, with the resin utilized and the pressure-induced reclosable seal strength results being summarized in Table I, below.

### Example 5

A fifth two-layer film was coextruded and tested for seal strength in the same manner as in Example 1. However, instead of the first layer being 100 weight percent ENGAGE® 8100 ethylene/octene copolymer, the first layer was 100 weight percent EXACT® 4049 ethylene/butene copolymer having a density of 0.873 g/cc, and a melt flow index of 4.5 decigram/minute, this resin having been obtained from Exxon-Mobil. The heat seal strength results of Example 5, and the pressure-induced reclosable seal strength results for Example 5, are provided in FIG. 3 and FIG. 4, respectively, with the resin utilized and the pressure-induced reclosable seal strength results being summarized in Table I, below.

TABLE I
Seal Strengths of Multilayer Films

| | | | | | Branches | | Seal |
|---|---|---|---|---|---|---|---|
| Example | | | | Density | per | MFI | Strength |
| No. | Material | Comonomer | Wt % | (g/cc) | 1000 C. | (dg/min) | [lbf/in] |
| 1 | Engage ® | Octene-1 | 37 | 0.870 | 47 | 1.0 | 0.05-0.2 |
| 2 | Engage ® | Octene-1 | 34 | 0.870 | 43 | 5.0 | 0.1-0.4 |
| 3 | Engage ® | Octene-1 | 38 | 0.864 | 49 | 13.0 | 0.5-1.2 |
| 4 | Engage ® | Octene-I | 45 | 0.857 | 54 | 1.0 | 0.9-1.5 |
| 5 | Exact 4049 | Butene-1 | 28 | 0.873 | 67 | 4.5 | 0.05-0.1 |

In summary of the pressure-induced reclosable seal strength results obtained, as can be seen in FIG. 4, all of the films exhibited at least some pressure-reclosable properties. The films of Examples 1, 2, and 5 exhibited relatively weak pressure-induced seals in the range of from 0.05 to 0.2 pounds force per inch (i.e., lbf/in). The films of Examples 3 and 4 formed stronger pressure-induced seals of 0.5 to 1.5 lbf/in, and for this reason it is apparent that ethylene/alpha-olefin elastomers with lower density are believed to form stronger pressure-induced seals. Table I summarizes the various ethylene/alpha-olefin elastomers used in Examples 1-5, as well as the pressure-induced seal strength of the seal layers of the films of Examples 1-5.

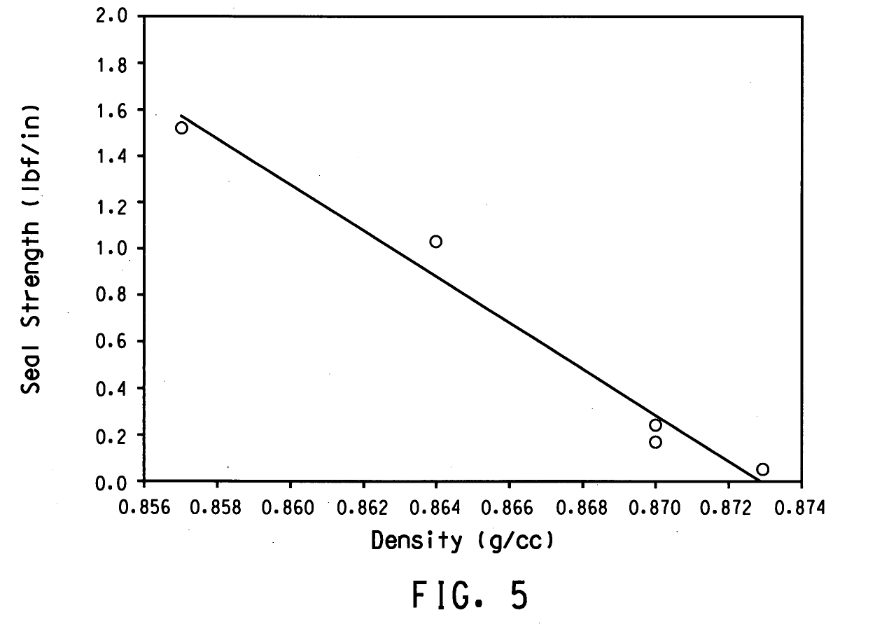

FIG. 5 is a plot of strength of pressure-induced seal as a function of the density of the ethylene/alpha-olefin elastomer present in the first layer of the 2-layer films of Examples 1-5. As can be seen in FIG. 5, seal strength was inversely proportional to density of the ethylene/alpha-olefin copolymer elastomer.

All subranges of all disclosed ranges are hereby expressly disclosed. All references herein to ASTM procedures are hereby incorporated, in their entireties, by reference thereto. Although the present invention has been described in conjunction with certain preferred embodiments, it is to be understood that modifications and variations can be utilized without departing from the principles and scope of the invention, as those skilled in the art will readily understand. Accordingly, such modifications can be practiced within the scope of the following claims.

What is claimed is:

1. A multilayer film comprising:
(a) a first layer comprising a branched polyethylene having a density of up to about 0.875 g/cc, said first layer being an outer layer that is hermetically heat-sealable and pressure-reclosable; and
(b) a second layer comprising a different thermoplastic polymer.

2. The multilayer film of claim 1, wherein the branched polyethylene is an ethylene/alpha-olefin elastomer.

3. The multilayer film of claim 1, wherein the branched polyolefin has:
(a) branches of only one, two, or three different branch lengths; or
(b) three or more branches of the formula —(CH₂CH₂)ₘH wherein m is an integer of one or more.

4. The multilayer film according to claim 2, wherein the ethylene/alpha-olefin elastomer comprises homogeneous ethylene/alpha-olefin copolymer.

5. The multilayer film according to claim 1, wherein the first layer is directly adhered to the second layer.

6. The multilayer film according to claim 4, wherein the homogeneous ethylene/alpha-olefin copolymer comprises metallocene-catalyzed ethylene/alpha-olefin copolymer.

7. The multilayer film according to claim 6, wherein the metallocene-catalyzed homogeneous ethylene/alpha-olefin comprises linear homogeneous ethylene/alpha-olefin copolymer.

8. The multilayer film according to claim 6, wherein the metallocene-catalyzed homogeneous ethylene/alpha-olefin comprises long-chain branched homogeneous ethylene/alpha-olefin copolymer.

9. The multilayer film according to claim 2, wherein the ethylene/alpha-olefin elastomer comprises a copolymer of ethylene and a C₃-C₂₀ olefin.

10. The multilayer film according to claim 1, wherein the branched polyethylene is an ethylene/alpha-olefin elastomer and has a density of from about 0.85 g/cc to 0.87 g/c.

11. The multilayer film according to claim 1, wherein the branched polyethylene is an ethylene/alpha-olefin elastomer and has a melt index of from about 0.5 grams/10 minutes to 20 grams/10 minutes.

12. The multilayer film according to claim 1, wherein the film is capable of exhibiting a 40 psi for one second at 30° C. pressure-induced reclose seal strength of at least 50 grams per centimeter for at least 2 repetitions.

13. The multilayer film according to claim 1, wherein the outer seal layer and the second layer are coextruded.

14. The multilayer film according to claim 1, wherein the film is produced using a lamination process.

15. The multilayer film according to claim 1, wherein the multilayer film further comprises an O₂-barrier layer.

16. The multilayer film according to claim 1, wherein the second layer comprises at least one member selected from a group consisting of olefin homopolymer, olefin copolymer, polyamide, polyester, ethylene/vinyl alcohol copolymer, halogenated polymer, polystyrene, styrene/butadiene copolymer, polynorbornene, ethylene/unsaturated ester copolymer, and ethylene/unsaturated acid polymer.

17. The multilayer film according to claim 2, wherein the branched polyethylene is an ethylene/alpha-olefin elastomer and is present in the outer heat seal layer in an amount of at least 20 weight percent, based on total layer weight.

18. The multilayer film according to claim 1, wherein the film has a total free shrink, at 185° F., of from about 15 to 150 percent.

19. The multilayer film according to claim 1, wherein the film has a total free shrink, at 185° F., of up to 10 percent.

20. The multilayer film according to claim 1, wherein the multilayer film has a thickness of up to about 50 mils.

21. The multilayer film according to claim 1, wherein at least one member selected from the first layer and the second layer comprises at least one member selected from slip agent and antiblock agent.

22. The multilayer film according to claim 21, wherein the first layer comprises at least one member selected from slip agent and antiblock agent.

23. The multilayer film according to claim 2, wherein the branched polyethylene is an ethylene/alpha-olefin elastomer and makes up 100 weight percent of the first layer.

24. The multilayer film according to claim 1, wherein the first layer comprises a blend containing:
(a) from about 15 to 99 percent, based on layer weight, of at least one member selected from a group consisting of homogeneous hyperbranched polyolefin and a branched polyethylene; and
(b) from about 1 to about 85 percent, based on layer weight, of at least one polymer selected from a group consisting of an olefin homopolymer having a density of at least 0.88 g/cc and an olefin copolymer having a density of at least 0.88 g/cc.

25. A packaging article comprising multilayer film having a first layer and a second layer, the first layer being an inside layer of the article, the first layer comprising a branched polyethylene having a density of up to about 0.875 g/cc, the second layer comprising a different thermoplastic polymer, with the inside layer heat sealed to itself or another component of the packaging article, and the inside layer being hermetically heat-sealable and pressure-reclosable to itself or the other component of the packaging article.

26. The packaging article according to claim 25, wherein the packaging article is a bag and the inside layer is hermetically heat sealed to itself.

27. The packaging article according to claim 25, wherein the multilayer film is heat-sealed to a second component which is molded or thermoformed.

28. A process for making a sealed article, comprising:
(a) providing a multilayer film having a first layer which is a heat-sealable pressure-reclosable layer and which comprises a branched polyolefin having a density of up to 0.875 g/cc;
(b) heat sealing the first layer of the multilayer film to itself or another article by heating the first layer to a temperature of at least 50° C.

29. A hermetically heat-sealable, pressure-reclosable multilayer film comprising:
(a) a first layer which is an outer film layer and which comprises a branched polyethylene having a density of up to 0.875 g/cc; and
(b) a second layer which is an outer, heat-resistant layer comprising a thermoplastic polyolefin having at least one of DSC melting point or glass transition of at least about 100° C.,
at least one of outer layer (A) and (B) having a coefficient of friction of less than 0.5 as measured by ASTM D 1894.

30. A package comprising a tray having a lidding film adhered thereto, the tray having a support member, upwardly extending walls, and a flange above the upwardly extending walls, with the lidding film being a multilayer film having a first layer and a second layer, the first layer being an inside heat-sealable, pressure-reclosable layer comprising a branched polyethylene having a density of up to 0.875 g/cc, the second layer comprising a different thermoplastic polymer.

31. The package according to claim 30, wherein the tray comprises a rigid member to which a flexible film is adhered, the flexible film comprising an O₂-barrier layer, and the lidding film comprising an O₂-barrier layer.

32. An article having a pressure-resealable closure comprising a first resealable surface and a second resealable surface, wherein a first material of said first resealable surface comprises a branched polyethylene having a density of up to about 0.875 g/cc, said branched polyethylene having:
(a) branches of only one, two, or three different branch lengths; or
(b) three or more branches of the formula —(CH₂CH₂)ₘH wherein m is an integer of one or more; and
a second material of said second sealing surface comprises a thermoplastic.

33. A process for closing a closure, comprising applying pressure so as to squeeze together a first resealable surface and a second resealable surface, wherein a first material of said first resealable surface comprises a branched polyethylene having a density of up to about 0.875 g/cc, said branched polyethylene having:
(a) branches of only one, two, or three different branch lengths; or
(b) three or more branches only of the formula —(CH₂CH₂)ₘH wherein m is an integer of one or more; and
a second material of said second sealing surface comprises a thermoplastic.
